(19) United States
(12) Patent Application Publication
(10) Pub. No.: US 2025/0388241 A1
(43) Pub. Date: Dec. 25, 2025

(54) FIXED-TRACK TRANSPORT DEVICE

(71) Applicant: ANTAL ZOMBORI, BUDAPEST (HU)

(72) Inventor: ANTAL ZOMBORI, BUDAPEST (HU)

(21) Appl. No.: 18/879,345

(22) PCT Filed: Jun. 12, 2023
(86) PCT No.: PCT/HU2023/050032

§ 371 Date: Dec. 27, 2024

(30) Foreign Application Priority Data
Jun. 28, 2022 (HU) P2200239

(51) Int. Cl. B61B 3/02; B61C 9/46; B61C 9/48

(52) U.S. Cl. CPC B61B 3/02; B61C 9/46; B61C 9/48

(57) ABSTRACT

The invention discloses a fixed-track transport device. having two parallel rails (2a, 2b) separated from each other by a rail gap (5), a carriage (1) being able to run along the rails (2a, 2b) with at least two wheel sets each having wheels (4a, 4b, 4c, 4d) bearing independently in a common axle of rotation (12a, 12b) fitted on the rails (2a, 2b), and at least one branch (E) containing additional rails (2c, 2d) is built into the pair of rails (2a, 2b), and the axles of rotation (12a, 12b) are connected to each other by a support (13) having a fixing console (8), at least two guide rollers (6a, 6b) located in the rail gap (5) are connected rotatably to the support (13) along the length thereof. and cach wheel (4a, 4b, 4c, 4d) of at least one of the wheel sets of the carriage (1) is equipped with an independent drive (14a, 14b) of adjustable power. and the transport device is provided with a power control unit.

The invention relates to a fixed-track transport device having two parallel rails separated from each other by a rail gap, a carriage being able to run along the rails with at least two wheel sets each having wheels bearing independently in a common axle of rotation fitted on the rails, and at least one branch containing additional rails is built into the pair of rails, and the axles of rotation are connected to each other by a support having a fixing console.

Fixed, usually suspended track transport means are solutions usually serving between two stations without branching, for example ski lifts. In the case of elevated railways, it is rare to see a solution where the vehicle can change its direction, but if yes, this also happens through a switching system, when the track intervenes as an active element in the vehicle's traffic, the vehicle cannot independently decide to change direction. A non-fixed track, free choice of direction type solution is better, since the vehicle can go in the direction of its choice regardless of the road at a junction, but the price of this freedom is that it cannot be automated in the case of today's systems, because many different traffic situations can occur. This problem can be encountered both in transport of passengers and goods, and in the case of the latter, often in warehousing.

In the case of fixed-track transport systems, such as railway tracks, or even suspended transport systems for goods, the change of direction of the train depends on the position of the switches. The switching can be adjusted independently of the vehicle, but in some systems, the switch can be adjusted as desired with the electrical or mechanical control device arranged on the vehicle, and with this the vehicle can choose the direction of travel. For such fixed-track systems, therefore, switches used are capable of mechanically transforming the configuration of rails in the area of the switch into all possible built-in travel directions, that is in each case they form a single route by positioning rail elements between the selected track sections before and after the switch. Since for the design, installation, operation and maintenance of switches is quite expensive compared to other sections of the track due to the moving parts that are also subject to considerable load, experts tried to create systems in which the change of direction can be realized without using moving parts built into the track.

Such a system is disclosed for example in published document KR 20210055292 B1, which describes a suspended transport device, where guide rails branching in different directions are arranged above branching track sections for controlling the direction of travel of the vehicle. The vehicle is equipped with a guide roller running between the rails and, in addition, an adjustable direction changing roller, which can be raised vertically to the height of the guide rail on the side of the guide rail corresponding to the selected direction, and as a result, the vehicle continues running along the forced track corresponding to the direction of the guide rail, while it is held on the track by guide rollers resting on the edge of the gap formed in the center line of the track between the rails. A suspension element for the cargo attached to the vehicle is located in the gap as well. The disadvantage of the solution is that a guide rail separated from the track i.e. an additional track element is needed to change the direction of travel of the vehicle on the one hand, and on the other hand the vehicle must be equipped with a direction selector roller that can be fitted to the guide rail, and a mechanism that moves the roller.

Therefore, object of this invention is to provide a fixed-track transport device in which, in order to change the direction of travel of the vehicle, there is no need for a guide rail separated from the track, i.e. an additional track element, and therefore a direction selector roller that can be attached to the additional track element, nor the complicated structure that moves it.

We recognized that if the torque acting on the driving wheels of the vehicle running on the two rails of the track is changed in such a way that the value of the torque is different, the force acting on the guide roller running in the gap formed in the center line of the track forces the guide roller into the gap of the branch element of the track located in the direction of the driven wheel with a smaller torque, and the vehicle continues its journey on the corresponding pair of rails.

We achieved our object by providing a fixed-track transport device having two parallel rails separated from each other by a rail gap, a carriage being able to run along the rails with at least two wheel sets cach having wheels bearing independently in a common axle of rotation fitted on the rails, and at least one branch containing additional rails is built into the pair of rails, and the axles of rotation are connected to each other by a support having a fixing console, at least two guide rollers located in the rail gap are connected rotatably to the support along the length thereof, and cach wheel of at least one of the wheel sets of the carriage is equipped with an independent drive of adjustable power, and the transport device is provided with a power control unit.

The wheels each having an independent drive of adjustable power and forming additional pair of wheels biased to the rail are connected by bearings on the fixing console.

The wheel forming the additional pair of wheels is mounted on a crank arm by bearings, and a biasing means is arranged between the crank arm and the fixing console.

The drive is arranged on the crank arm.

The biasing means is a spring.

The fixed-track transport device according to the invention will be described in detail below with reference to the attached drawing. In the drawing

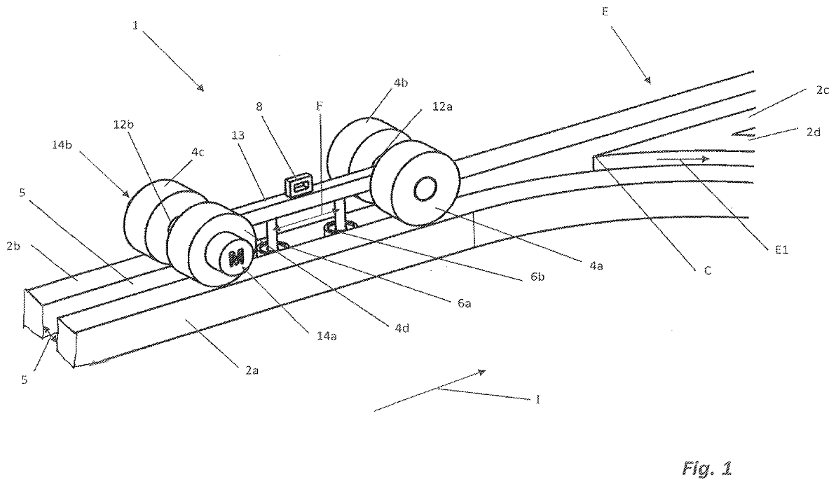

FIG. 1 is a perspective view of an advantageous embodiment of the transport device according to the invention,

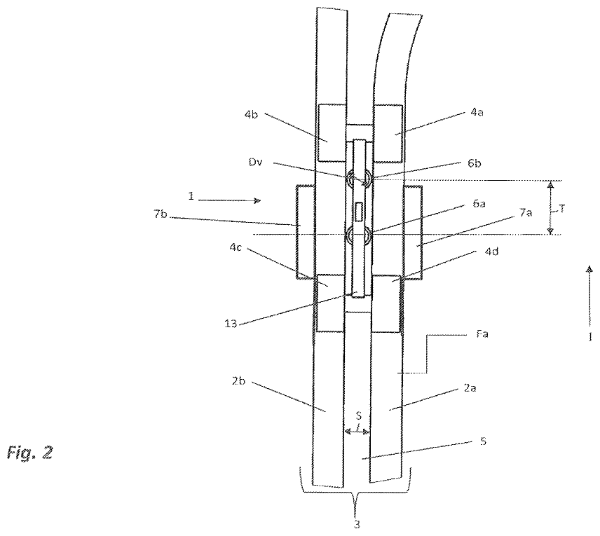

FIG. 2 shows another embodiment of the carriage of the transport device according to the invention in a top view, a

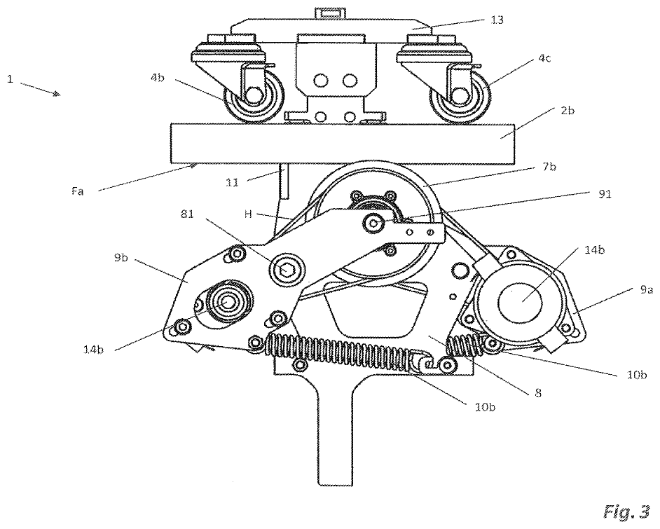

FIG. 3 shows a preferred embodiment of the carriage in side elevation view,

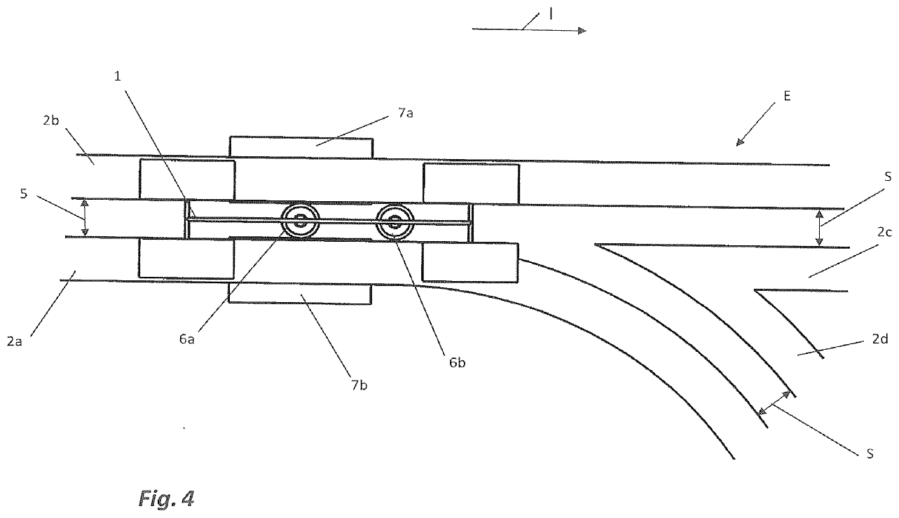

FIG. 4 shows the carriage in top view, before changing direction, and

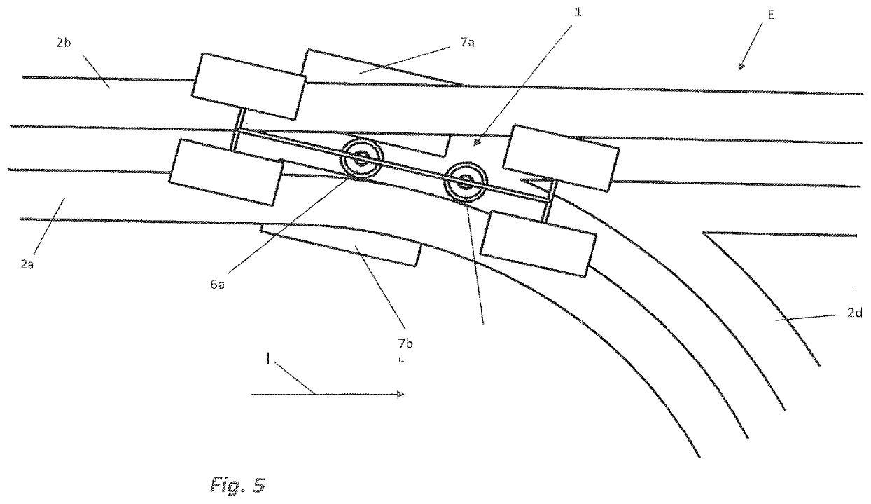

FIG. 5 shows the position of the carriage, after changing direction.

FIG. 1 shows a perspective view of one of advantageous embodiments of the fixed-track transport device according to the invention. Two parallel rails 2a, 2b separated by a rail gap 5 are arranged in the transport device. 1 carriage equipped with at least two wheel sets each having two 4a,4b,4c,4d wheels bearing independently in a common axle of rotation 12a, 12b is fitted on the 2a, 2b rails. The transport device is also provided with at least one branch E containing additional rails 2c, 2d. The two axles 12a, 12b are connected by a support 13 provided with a cargo fixing console 8 of arbitrary design and placement, which in this embodiment is the bracket eye 8, to which e.g. a container suitable for transporting objects can be attached/hung. Along the length of the support 13, at least two running guide rollers 6a, 6b located in the rail gap 5 are rotatably attached successively to the support 13 so that during the movement of the carriage 1, the guide rollers 6a, 6b touch the rails 2a, 2b and prevent the carriage from leaving the track formed by the rails 2a, 2b. The wheels 4a, 4b, 4c, 4d, e.g. the wheels 4c, 4d forming one of the wheel sets of the carriage 1 are equipped with an independent drive unit 14a, 14b with individually adjustable power for each wheel 4c. 4d, which are e.g. motors mounted directly on the axle 12b of rotation. The power supply of the drive unit 14a, 14b is provided in a manner known per se, e.g. it can be solved with batteries arranged on the carriage 1, not shown in the figure, or by using an overhead line. The transport device is also suitable for controlling the performance of the motors 14a, 14b, e.g. it is equipped with an electronic control unit, so the torque acting on wheels 4c, 4d can be changed.

If the planned route of carriage 1 runs in the direction El at the branch E shown in the figure, the control unit increases the torque of the drive unit 14b of the wheel 4c before the tip C of the branch E, and thereby presses the guide roller 6b against the rail 2a. Therefore, during the movement of the carriage 1, the roller 6b keeps along the rail 2a in direction El, enters between the rails 2a, 2d, and guides the wheels 4a, 4b on the corresponding rails 2a, 2d. Meanwhile, as the guide roller 6a approaches the tip C of the branch E, the control unit increases the torque of the drive 14a of the wheel 4d, thereby pressing the guide roller 6a against the rail 2a. As a result, the guide roller 6a is definitely forced in the direction E1 and the change of direction is completed.

FIG. 2 shows a further advantageous embodiment of the carriage 1 of the fixed-track transport device according to the invention in a top view. The carriage 1 rests on the upper surface Ff of the pair 3 of rails consisting of two parallel rails 2a, 2b, with two wheels 4a, 4b, 4c, 4d for each rail 2a, 2b. Between the rails 2a, 2b there is a gap 5 of width S, in which the free-running guide rollers 6a, 6b of the 1 carriage are located. The diameter Dv of the guide rollers 6a, 6b is smaller than the width S of the rail gap 5, therefore the guide rollers 6a, 6b are only in contact with the edge of one of the rail strands 2a, 2b at any given time. The difference between the diameter Dv and the width S is ideally 0.1-2% of the width S. Unlike the embodiment shown in FIG. 1, the carriage 1 is preferably equipped with one driving wheel 7a, 7b for each of the rails 2a,2b, biased to the lower Fa surface of the rails 2a, 2b. The driving wheels 7a, 7b, the guide rollers 6a, 6b, and the suspension wheels 4a, 4b, 4c, 4d are attached to the carriage 1. In the illustrated embodiment, the axis of rotation of the guide roller 6a intersects the axis of rotation f of the drive wheels 7a, 7b, while the guide roller 6b is located at an arbitrary distance T in the direction I of travel from the axis of rotation f of the drive wheels 7a, 7b, near the suspension wheels 4a, 4b.

FIG. 3 shows a further preferred embodiment of carriage 1 shown in FIG. 2 in a side elevation view. In the figure it can be observed that the drive wheel 7b is rotatably arranged around the pivot point 91 on the crank arm 9b bearing on a pending console 8 at the pivot point 81. The console 8 and the crank arm 9b are connected by a tension spring 10b, which tightens the drive wheel 7b bearing on the bracket 9b to the lower Fa surface of the rail 2b. A similar arrangement is formed on the side corresponding to the drive wheel 7a, which is not shown in the figure. The console 8 is connected to the support 13 connecting the suspension wheels 4b, 4c to each other, with at least one suspension rod 11. The drive wheel 7b is connected with a belt to the drive 14b fixed on console 8. A similar arrangement is provided on the side corresponding to the drive wheel 7a, where the drive wheel 7a is driven by a motor 14a, that is the drive wheels 7a, 7b of the carriage 1 are provided with independent drive 14a,14b. The torque of the individual motor drives 14a, 14b, can be controlled by means of a known built-in control not shown in the figure.

In FIG. 4 the carriage 1 can be seen in a top view, before changing its direction. In the branch E of the rail pair 3, rails 2c, 2d start by the same common peak between the rails 2a, 2b that diverge in a curve, where the rail 2c runs parallel to the rail 2b, while the rail 2d runs parallel to the rail 2a. The width S of the rail gap 5 between the rails 2b,2c and 2a,2d is the same as the width of the rail gap 5 between the rails 2a,2b. Since the driving wheels 7a, 7b of carriage 1 are equipped with independent drives, the motors 14a, 14b, not shown here, but shown in FIG. 3, can be controlled independently of each other, in a manner otherwise known to the person skilled in the art, and thus the torque acting on the driving wheels 7a, 7b can be different. If the carriage 1 in the branch E has to continue to run on the pair of rails formed by the rails 2a, 2d, the ratio of the torque exerted by the motor 14a on the drive wheel 7a and the torque exerted by the motor 14b on the drive wheel 7b is regulated so that the torque acting on the drive wheel 7b is greater. As a result, the guide roller 6b located near the suspension wheels 4 turns around the axis of rotation of the guide roller 6b and presses against the rail 2a, and in the branch E it runs into the rail gap 5 between the rails 2a, 2d, and the guide roller 6a reaching the branch E follows it in this rail gap 5, that is the direction of the carriage 1 has changed. In order to ensure safe tracking, i.e. so that the guide roller 6a does not accidentally run into the rail gap 5 formed by the rail fibers 2b,2c, it is advisable to shift the position of the guide roller 6a from the common axis of rotation of the drive wheels 7a, 7b in the direction I of travel towards the guide roller 6b, because in this case the torque difference acting on the drive wheels 7a, 7b forces the roller 6a to the rail 2a as well. The position of carriage 1 after changing direction is shown in FIG. 5.

In summary, the fixed-track transport device according to the invention I provided with two parallel rails 2a, 2b separated from each other by a rail gap 5, a carriage 1 being able to run along the rails 2a, 2b with at least two wheel sets cach having wheels 4a,4b,4c,4d bearing independently in a common axle of rotation 12a, 12b fitted on the rails 2a, 2b, and at least one branch E containing additional rails 2c,2d built into the pair of rails 2a, 2b. The axles of rotation 12a, 12b are connected to each other by a support 13 having a fixing console 8. At least two guide rollers 6a, 6b located in the rail gap 5 are connected rotatably to the support 13 along the length thereof, and each wheel 4a,4b,4c,4d of at least one of the wheel sets of the carriage 1 is equipped with an independent drive 14a, 14b of adjustable power. The transport device is provided with a power control unit. Each wheel 7a, 7b forming an additional pair of wheels 7a, 7b having an independent drive (14a, 14b) of adjustable power and biased to the rail (2a, 2b) are connected by bearings 91 on the fixing console 8. 3. The wheel 7a, 7b forming the additional pair of wheels 7a, 7b is mounted on a crank arm 9a, 9b by bearings, and a biasing means is arranged between the crank arm 9a, 9b and the fixing console 8. The drive 14a, 14b is preferably arranged on the crank arm 9a, 9b. The biasing means is a spring 10a, 10b.

The advantage of the fixed-track transport equipment according to the invention compared to the state-of-the-art devices is that in order to change the direction of travel of the vehicle traveling in the device, there is no need neither for a guide rail separated from the track, i.e. an additional track element, and therefore a direction selector roller to be fitted to the additional track element, nor the complicated and expensive structure to move it. The transport device according to the invention can be used without any particular limitations in high-speed railways, freight and passenger tracks, as well as in transport and storage systems for goods in warehouses.

1. Fixed-track transport device, having two parallel rails (2a, 2b) separated from each other by a rail gap (5), a carriage (1) being able to run along the rails (2a, 2b) with at least two wheel sets each having wheels (4a,4b,4c,4d) bearing independently in a common axle of rotation (12a, 12b) fitted on the rails (2a, 2b), and at least one branch (E) containing additional rails (2c,2d) is built into the pair of rails (2a, 2b), and the axles of rotation (12a, 12b) are connected to each other by a support (13) having a fixing console (8), characterized by at least two guide rollers (6a, 6b) located in the rail gap (5) are connected rotatably to the support (13) along the length thereof, and each wheel (4a,4b,4c,4d) of at least one of the wheel sets of the carriage (1) is equipped with an independent drive (14a, 14b) of adjustable power, and the transport device is provided with a power control unit.

2. The fixed-track transport device according to claim 1, characterized in that wheels (7a, 7b) each having an independent drive (14a, 14b) of adjustable power and forming additional pair of wheels (7a, 7b) biased to the rail (2a, 2b) are connected by bearings (91) on the fixing console (8).

3. The fixed-track transport device according to claim 2, characterized in that the wheel (7a, 7b) forming the additional pair of wheels (7a, 7b) is mounted on a crank arm (9a, 9b) by bearings, and a biasing means is arranged between the crank arm (9a, 9b) and the fixing console (8).

4. Fixed-track transport device according to claim 3, characterized in that the drive (14a, 14b) is arranged on the crank arm (9a, 9b).

5. Fixed track transport device according to claim 4, characterized in that the biasing means is a spring (10a, 10b).
